(19) United States
(12) Patent Application Publication
(10) Pub. No.: US 2013/0332205 A1
(43) Pub. Date: Dec. 12, 2013

(54) SYSTEM AND METHOD FOR ESTABLISHING AN INSURANCE POLICY BASED ON VARIOUS FARMING RISKS

(71) Applicants: David Friedberg, San Francisco, CA (US); Erik Andrejko, Oakland, CA (US); James Ethington, San Francisco, CA (US); Siraj Khaliq, San Francisco, CA (US); Christopher Seifert, San Francisco, CA (US); Qaseem Ahmed Shaikh, Emeryville, CA (US); Tristan d'Orgeval, San Francisco, CA (US)

(72) Inventors: David Friedberg, San Francisco, CA (US); Erik Andrejko, Oakland, CA (US); James Ethington, San Francisco, CA (US); Siraj Khaliq, San Francisco, CA (US); Christopher Seifert, San Francisco, CA (US); Qaseem Ahmed Shaikh, Emeryville, CA (US); Tristan d'Orgeval, San Francisco, CA (US)

(21) Appl. No.: 13/842,752

(22) Filed: Mar. 15, 2013

Related U.S. Application Data
(60) Provisional application No. 61/656,447, filed on Jun. 6, 2012.

(51) Int. Cl. G06Q 40/08; G06Q 50/02

(52) U.S. Cl. CPC G06Q 40/08; G06Q 50/02
USPC 705/4

(57) ABSTRACT

A system and method for generating an insurance policy to protect a crop against weather-related perils is provided. A customized insurance policy is generated based on crop type data and location data. The customized insurance policy is generated utilizing a weather-impact model for the type of crop and the geographic area.

### CLAIM OF PRIORITY

This patent application claims the benefit of priority, under 35 U.S.C. Section 119(e), to U.S. Provisional Patent Application Ser. No. 61/656,447, filed Jun. 6, 2012, which is hereby incorporated herein by reference in its entirety.

### TECHNICAL FIELD

Example embodiments of the present disclosure generally relate to a data processing system and, more specifically, in some non-limiting example embodiments, to a system and method for generating a policy document to insure against loss based on one or more determined and estimated perils.

### BACKGROUND

Crop insurance exists to protect agricultural producers against the loss of their crops due to natural disasters or the loss of revenues due to declines in agricultural commodities prices. One type of crop insurance currently available is multi-peril crop insurance (MPCI). MPCI is usually offered by a government insurer and provides coverage based on actual production history (APH). As a result, there are limitations to how much coverage the grower can get from the federal program. The bigger the gap between the APH in previous years and the yields the grower expects to achieve in the current year, the less effective crop insurance is at providing adequate protection.

### BRIEF DESCRIPTION OF THE DRAWINGS

Example embodiments of the present disclosure are illustrated by way of example, and not by way of limitation, in the figures of the accompanying drawings.

FIG. 1 is a diagram depicting a network system, according to some example embodiments, including a client-server architecture configured for exchanging data over a network.

FIG. 2 is a diagram depicting a network system, according to some example embodiments, having multiple systems configured for exchanging data over a network.

FIG. 3A is a diagram illustrating modules of a computer system, according to some example embodiments.

FIG. 3B is a diagram illustrating modules of a location module in a computer system, according to some example embodiments.

FIG. 4 is a flow diagram of a method for generating a policy, according to some example embodiments.

FIG. 5 is a flow diagram of a method for estimating the temperature of a property parcel, according to some example embodiments.

FIG. 6 is a flow diagram of a method for estimating soil moisture for a property parcel, according to some example embodiments.

FIG. 7A is a flow diagram of a method for generating a policy to provide crop protection coverage against weather-related perils, according to some example embodiments.

FIG. 7B is a flow diagram of a further method for generating a policy, according to some example embodiments.

FIG. 8 is a diagram of a user interface for generating a policy to provide crop protection coverage against weather-related perils, according to some example embodiments.

FIG. 9 is a diagram of a user interface for providing a graphical display of weather risk for a property parcel, according to some example embodiments.

FIG. 10 is a diagram of a user interface for displaying a risk exposure for reliance solely on MPCI coverage, according to some example embodiments.

FIG. 11 is a diagram of a user interface for displaying the benefits of a supplemental insurance policy, according to some example embodiments.

FIG. 12 is a diagram of a user interface for illustrating the benefits of a supplemental insurance policy for various situational outcomes, according to some example embodiments.

FIG. 13A is a diagram of a user interface for illustrating the benefits of a supplemental insurance policy for different perils and different stages of maturity for an agricultural product, according to some example embodiments.

FIG. 13B is a diagram of a user interface associated with the growth stage tracker module.

FIG. 14 is a diagram of a user interface for receiving a selection of a rainfall grid, according to some example embodiments.

FIG. 15 is a diagram of a user interface for receiving a selection of a weather station, according to some example embodiments.

FIG. 16 is a diagram of a user interface of a weather risk report for an agricultural producer, according to some example embodiments.

FIG. 17A is a diagram of a user interface for depicting coverage against a first peril, according to some example embodiments.

FIG. 17B is a diagram of a user interface for depicting coverage against a second peril, according to some example embodiments.

FIG. 17C is a diagram of a user interface for depicting coverage against a third peril, according to some example embodiments.

FIG. 17D is a diagram of a user interface for depicting coverage against a fourth peril, according to some example embodiments.

FIG. 17E is a diagram of a user interface for depicting a soil moisture model, according to some example embodiments.

FIG. 17F is a diagram of a user interface for depicting a soil moisture tracker, according to some example embodiments.

FIG. 17G is a diagram of a user interface for depicting coverage against a fifth peril, according to some example embodiments.

FIG. 18 shows a diagrammatic representation of a machine in the example form of a computer system within which a set of instructions may be executed to cause the machine to perform any one or more of the methodologies discussed herein.

### DETAILED DESCRIPTION

Systems, methods, and machine-readable storage media storing a set of instructions for generating an insurance policy based on data defining various perils are disclosed. In the following description, for purposes of explanation, numerous specific details are set forth in order to provide a thorough understanding of the present disclosure. It may be evident, however, to one skilled in the art that the subject matter of the present disclosure may be practiced without these specific details.

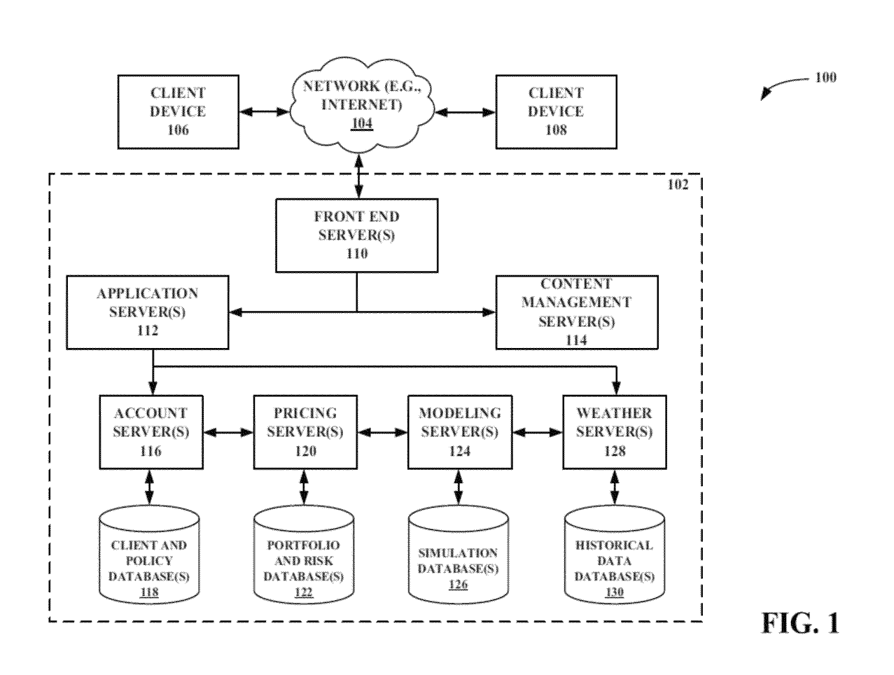

FIG. 1 is a network diagram depicting a network system 100, according to one example embodiment, having a client-server architecture configured for exchanging data over a network. One or more client devices 106, 108 may communicate and exchange data via a network 104 (e.g., the Internet) with an application platform 102. Although illustrated herein as a client-server architecture, other example embodiments may include other network architectures, such as a peer-to-peer or distributed network environment. In one embodiment, the system permits a user to request customized weather-based coverage for a specified type of crop grown in a specified geographic area. Based on the type of crop grown in a specified geographic area, an example system may determine one or more categories of weather perils for the type of crop and the geographic area. The system may further identify one or more respective threshold values and one or more respective payout rules for each category of weather perils. A threshold value may specify, e.g., the maximum allowable occurrence of a peril. For example, where a weather peril is heat stress that may affect the growth of a crop, a threshold value may relate to the amount of time the crop is exposed to elevated temperatures. A payout rule specifies an amount to be paid to the policy holder if the associated threshold value is exceeded. In some embodiments, the system may be configured to identify a model and determine the configuration of that model based on one or more categories of weather perils for the crop type data and the location data. The system may also identify one or more sub-models of the model, each sub-model having a respective threshold or a set of threshold values and respective one or more payout rules.

In one embodiment, for each type of crop that that can be covered by one or more insurance policies, a number of models may be built that encompass the relationship between weather, location, soil moisture, and the bushels of production per acre of land (yield). Those weather/yield models may be broken down for each weather peril. As the weather perils are often related, since drought, excess moisture, heat stress, etc. weather conditions and yield losses are not independent of each other a unified weather/yield model may be generated for each crop. In some embodiments, a unified weather/yield model may be provided that ties all of those weather perils together. An insurance policy may simply say that if the TCC Weather/Yield Index (or some other predetermined parameter) is below a certain threshold value at the end of the growing season for the subject crop type, then the policyholder will be entitled to a payment. And the amount of that payment would scale up or down depending on how much of a shortfall there is. A Weather/Yield Index value and the amount of the payment may be used to represent the model's estimate of all the losses the policyholder would have suffered from all of the covered weather perils taken together. In yet another embodiment, hybrid approach may be used, where a model may treat some of the weather perils independent form other weather perils.

A system for generating a crop insurance policy may thus receive crop type data indicating a type of crop, receive location data indicating a geographic area and determine a weather impact model based on one or more categories of weather perils for the type of crop and the geographic area. The weather impact model may be used for determining the impact of weather events on a crop. The system may then generate, based on the determined weather impact model, a crop insurance policy for the type of crop and the geographic area. The system may also be configured to define sub-models for the crop type data and the location data, and define respective one or more thresholds values and respective one or more payout rules. The thresholds and the payout rules may be used to generate a crop insurance policy.

The application platform 102 may provide server-side functionality, via the network 104 to one or more client devices 106, 108. In various example embodiments, the client devices 106, 108 may access the application platform 102 via a web client or a programmatic client. The client devices 106, 108 may transmit data to, and receive data from, one or more front end servers 110. In some example embodiments, the data may take the form of requests and user information input into the client devices 106, 108. One or more front end servers 110 may process the client device requests and user information and determine whether the requests are service requests or content requests, among other things. Content requests may be transmitted to content management server(s) 114 for processing and retrieval of content. Application requests may be transmitted to one or more application servers 112.

In some example embodiments, application requests may take the form of a request to generate a policy to insure against one or more perils. In some example embodiments, the policy may cover agricultural assets (e.g., crops, livestock) of a user from one or more perils (e.g., drought, excessive rain, high temperatures, freezes, etc.). The application servers 112 may process the request and issue one or more calls to one or more services to aid in the generation of the policy. For example, the application servers 112 may call one or more account servers 116 to initiate the policy generation process. Initiation of the policy generation process may include determining whether the user is a new customer or an existing customer. The account servers 116 may determine the status and identity of the customer by issuing a query to a client and policy database 118 and by retrieving any information related to the customer in response to the query. The initiation of the policy generation process may further include determining whether the request pertains to an existing policy or a new policy. The status of the policy may be determined by querying the client and policy database 118 and retrieving any information related to the policy.

If it is determined that the user is a new customer, the user may be prompted via one or more user interfaces to input identifying information about the user, including both personal information and information regarding the user's land, equipment, and/or agricultural assets sought to be protected. For example, the user may be required to input information that identifies one or more of the land that the user farms, the type of crops and/or livestock the user raises, the type of equipment owned by the land, and historical data relating to the performance (e.g., yield) of the assets raised by the user, and so on. Identification of land may include a lot and block number, a parcel number, geographic coordinates and boundaries, Farm Serial Number (FSN), farm number, tract number, field number, selection of a common land unit (CLU), section, township, range, or other types of identification used to specify the land owned or leased by a user. According to the Farm Service Agency, a Common Land Unit (CLU) is the smallest unit of land that has a permanent, contiguous boundary, a common land cover and land management, a common owner and a common producer in agricultural land associated with USDA farm programs. CLU boundaries are delineated from relatively permanent features such as fence lines, roads, and/or waterways. Crop information may include a type of crop, crop variety, crop rotation, tillage, tiling, and relative maturity, amount/timing of fertilizer used, whether the crop is grown organically, how often the crop is irrigated, and so forth. Equipment information may include the type of equipment used to plant and harvest the agricultural assets. Historical data may include historical crop yields, historical crop prices and crop revenue, weather information (e.g., temperature, rainfall) to the extent maintained or accessible by the user, and so forth.

If it is determined that the user is seeking a policy for new coverage, similar information as stated above with respect to the user being a new customer may be requested from the user. Based on the information provided by the user, the account service provided by the account servers 116 may communicate with one or more pricing servers 120 to determine a price of the policy. The pricing servers 120 may query a portfolio and risk database 122 to determine risk factors associated with the crop and the location where the crop is grown. To aid in the assessment of risk, the pricing servers 120 may communicate with one or more modeling servers 124 to determine weather data related to the land on which the crop is grown. The modeling servers 124 may communicate with one or more weather servers 128 to access historical weather data for the location where the crop is grown. The weather servers 128 may query historical data databases 130 to retrieve historical weather data. Historical weather data may include temperature and rainfall data for a particular location. In some example embodiments, historical weather data may not be available for the location in question. In these instances, in some example embodiments, historical weather data from the weather station located nearest to the location in question may be retrieved. In other example embodiments, the user may be prompted to select a weather station located near the location in question via a user interface. In some example embodiments, the user interface may graphically display a map of the location in question and one or more weather stations located proximally to the location in question. In other example embodiments, a listing of weather stations located proximally to the location in question may be presented to the user via the user interface. Other approaches for obtaining historical weather data may include utilizing gridded temperature datasets.

The historical weather data retrieved by the weather servers 128 may be returned to the modeling servers 124 for use in determining aspects of the weather related to the location in question. In some example embodiments, the historical weather data may be used to simulate weather conditions for the location in question. The modeling servers 124 may generate a predetermined number of simulations (e.g., 10,000 simulations) of weather using, in part, the historical weather data and store the simulations in a simulation database 126. The actual and/or simulated weather data may be returned to the pricing servers 120 for use in pricing the policy. The account servers 116 may return the priced policy to the application servers 112 for transmission to the requesting client device 106, 108 via the network 104.

In some example embodiments, the application platform 102 may comprise one or more systems in communication with each other. For example, a front end system may comprise the front end servers 110, the application servers 112, and the content management servers 114. A back end system may comprise the account servers 116, pricing servers 120, modeling servers 124, weather servers 128, and the corresponding databases 118, 122, 126, and 130. In some example embodiments, the back end system may be third party-hosted servers that provide services to the front end system via Application Program Interface (API) requests and responses. For example, the back end system may comprised cloud-based servers that host and process the data and services used to generate a policy. Although the aforementioned servers have been configured as a front end system and a back end system, one skilled in the art will appreciate that any configuration of servers may be possible and that example embodiments of the present disclosure need not be limited to the configurations disclosed herein.

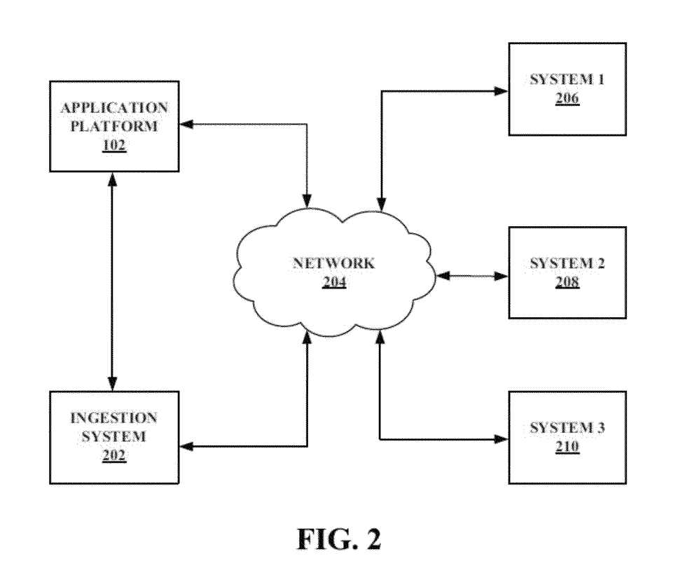

FIG. 2 is a diagram depicting a network system, according to some example embodiments, having multiple systems configured for exchanging data over a network. Referring to FIG. 2, a network system is depicted in which the application platform 102 of FIG. 1 is connected, via a network 204, to three example systems 206, 208, 210 and an ingestion system 202. The three example systems 206, 208, 210, may represent various external systems from which data may be retrieved. For example, in some example embodiments, example system 206 may represent a system associated with the National Oceanic and Atmospheric Administration that provides precipitation data for predetermined geographical grid sizes (e.g., 2.5 miles by 2.5 miles). In some example embodiments, example system 208 may represent one or more weather stations located throughout the United States (or any other associated geographical area) that provide temperature data. In some example embodiments, example system 210 may represent a system associated with the United States Department of Agriculture that provides data related to agricultural production. It should be appreciated that the example systems 206, 208, 210 illustrated in FIG. 2, or further example systems, may represent other sources of data, such as sources of soil type data, historical data, crop yield data, temperature data, and so forth, which are published or otherwise made available for consumption.

The ingestion system 202 may consume data published or made available by the example systems 206, 208, 210. The frequency at which the data is published may vary based on the type of data. In some example embodiments, a notification may be sent to the ingestion system 202 when new data is made available by a data source. The ingestion system 202 may transmit an API call via the network to the system hosting the data and may receive the new data in response to the call. To the extent needed, the ingestion system 202 may process the data to enable components of the application platform 102 to handle the data. For example, processing data may involve extracting data from a stream or data feed and mapping the data to a data structure, such as an XML data structure. Data received and/or processed by the ingestion system 202 may be transmitted to the application platform 102 and stored in an appropriate database. Although the ingestion system 202 is shown as a separate system from the application platform 102 in FIG. 2, it should be appreciated that the ingestion system 202 may be a part of the application platform 102.

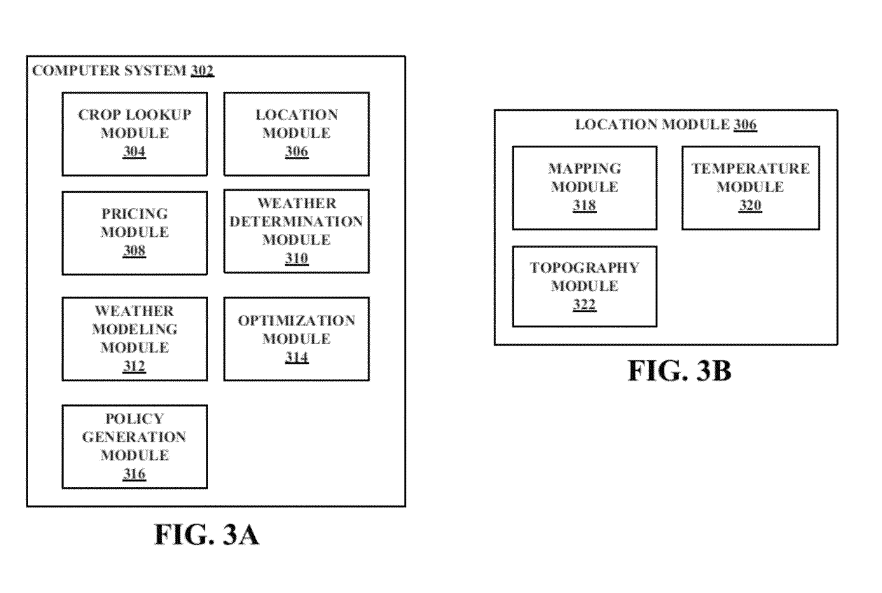

FIG. 3A is a diagram illustrating example modules of a computer system 302, according to some example embodiments. The computer system 302 may store and implement one or more modules. Although the computer system 302 is depicted as storing and implementing the modules, it is contemplated that multiple components or systems of the application platform 102 may each store and implement one or more of the modules depicted in FIG. 3A.

The computer system 302 may store a crop lookup module 304, a location module 306, a pricing module 308, a weather determination module 310, a weather modeling module 312, an optimization module 314, and a policy generation module 316. In some example embodiments, each module may be a hardware component within the computer system 302. In other example embodiments, each module may be software that configures one or more processors (e.g., microprocessor, microcontroller, application specific integrated circuit, field programmable gate array) to perform certain functionality.

The crop lookup module 304 may receive information submitted by a user regarding the type of crop being grown by the user. In response thereto, the crop lookup module 304 may retrieve information related to the crop for use in generating the policy. For example, the information related to the crop may include the growth cycle of the crop, optimal range of temperature and precipitation for the crop, temperature and precipitation tolerances for the crop, and so forth.

The location module 306 may be configured to receive and store location data indicating a geographic area. The location module 306 may also be configured to determine a geographical location at which the crop is grown by the user.

The location may vary in granularity. For example, in some example embodiments, the location may be as large as a county or district in a region, such as a state or province. The county or district may be specified by the user. In some example embodiments, the location may comprise one or more parcels of a predetermined size. For example, a farm may comprise one or more parcels (e.g., 2.5 miles by 2.5 miles, 5 miles by 5 miles). In some example embodiments, the user may provide general coordinates or boundaries for a farm associated with the user. Based on the general coordinates or boundaries, one or more parcels that correspond to the farm may be determined by the location module 306. This determination may be aided by satellite or other mapping techniques. The location module 306 may also be configured to determine a common land unit (CLU) associated with a specific location on a map and, optionally, highlight the portion of the displayed map that corresponds to that CLU. In one embodiment, the location module 306 may provide a map presentation to a user, receive a selection of a location on the presented map, identify a CLU associated with the selection of the location on the presented map, and identify the common land unit as the geographic area where potentially insured crop is being or is going to be grown. I a further embodiment, a geographic area may be determined by receiving an indication of a point on a map presentation and a number of acres.

The pricing module 308 may generate a price for an insurance policy that insures against the occurrence of certain weather perils. The pricing module may process data representing a plurality of factors. Example factors taken into account may include the type of crop being grown, the location of a property growing the crop, historical and estimated weather data (e.g., precipitation, temperature), prior crop yields, prior insurance claims by the user and/or by users in the region of the property, the probability of various perils occurring during different stages of the crop's growth cycle, and so forth. Based on the various factors, the pricing module 308 may generate a premium cost for purchasing the insurance policy, as well as one or more payout schedules for the occurrence of certain perils. In some example embodiments, the payout schedules may specify a payment for the occurrence of certain perils irrespective of whether the crop is actually damaged by the peril. Further, the policy may permit a user to collect payments for each occurrence of each peril during a coverage period.

The weather determination module 310 may access stored weather data to determine certain weather aspects for the determined location. For example, the weather determination module 310 may determine temperature and precipitation for each parcel of land using data stored in a database or obtained from one or more sources external to the application platform 102.

The weather modeling module 312 may be configured to identify one or more categories of weather perils for a specific crop type data and the geographic area. The weather modeling module 312 may simulate certain weather aspects for each parcel of land. In some example embodiments, simulation may be performed in the event weather data is not available for the parcels of land. In some example embodiments, the simulation may use weather data obtained from the closest proximate location to the parcels of land, while in other example embodiments, a user may specify one or more weather stations from which to obtain weather data for use in the simulation. The weather modeling module 312 may generate a plurality of simulations based on the obtained weather data and may estimate the weather of the parcels of land based on the plurality of simulations. For example, the weather modeling module 312 may be configured determine a weather impact model based on one or more categories of weather perils for the type of crop and the geographic area; and the policy generation module 316 may generate a policy based on the weather impact model, using at least one processor, a crop insurance policy for the type of crop and the geographic area.

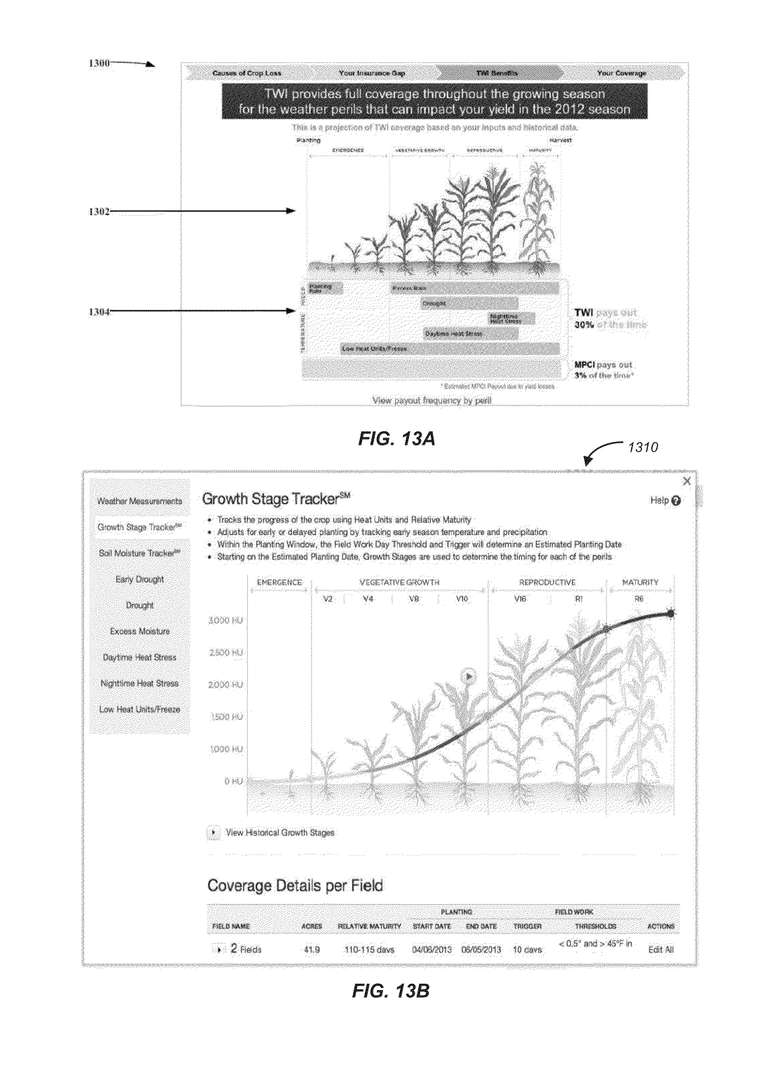

The policy generation module 316 may generate a policy based on the various inputs (e.g., crop type, location, weather) received and determined by the modules discussed herein. The policy may insure against the occurrence of various perils that may occur during the growth cycle of the crop. The policy generation module 316 may generate a plurality of crop insurance policies based on the one or more categories of weather perils applicable to the type of crop and the geographic area and a respective coverage level. The policy generation module 316 may generate insurance policy quotes for multiple fields in a parcel and thus support real-time customization across many fields in a short amount of time. The system 302 of FIG. 3A may also include a presentation module (not shown) to cause to be displayed at least one user interface element configured to be selected by a user to request the crop insurance policy. For example, the policy generation module 316 may generate three policies providing respective coverage levels and present the three options to the user: a break-even coverage, a profit coverage, and a maximum profit coverage, where each option has its respective estimated premium amount. The system 302 of FIG. 3A may also include a communication module (not shown) to receive a selection of a crop insurance policy from the plurality of crop insurance policies, the selection being indicative of a request for the crop insurance policy by a user. Thus, a feature may be provided that allows for coverage level to be selected dynamically and in reference to the multi-peril crop insurance (MPCI) and estimated crop yield, based on weather data. The system 302 of FIG. 3A may also include a growth stage tracker module (not shown) to establish a range of dates for a category of weather peril corresponding to a portion of a planting season for the type of crop, wherein the payout rule utilizes a number of days within the range of dates when the threshold is exceeded. The growth stage tracker module adjusts the range of dates for each weather peril corresponding to a portion of the planting season for the type of crop indicated by the crop type data, based on an agronomic model of crop growth. The growth stage tracker module may also be configured to determine the payout rule based on tracked progress of the crop type data and the location data. An example user interface associated with the growth stage tracker module is shown in FIG. 13B, which is described further below.

FIG. 3B is a diagram illustrating example sub-modules of a location module 306 in a computer system, according to some example embodiments. In some example embodiments, the location module 306 discussed with reference to FIG. 3A may include one or more sub-modules, such as a mapping module 318, temperature module 320, and topography module 322. The mapping module 318 may be used to identify specific parcels of land belonging to a farm being used to grow a crop. The parcels of land may be of a predetermined size and may have no relation to the actual dimensions or boundaries of the farm. Rather, in some example embodiments, each parcel may be a standard size, such as a 2.5 mile by 2.5 mile square. In some example embodiments, the mapping module 318 may aid in the identification of relevant parcels by superimposing an outline of the individual fields or CLUs for the parcels over a map of the region in which the farm is located. Based on data provided by the user, the location module 306 may be able to identify and select the relevant parcels for use in generating the policy. As mentioned above, a specific parcel of land may be identified based on identifying an associated CLU or, e.g., using farm serial number, etc.

The temperature module 320 may be used to determine the temperature of the identified parcels of land over a period of time. In some example embodiments, the temperature module 320 may access a list of weather stations located in the region of the parcels of land being used to grow the crop and may select one or more weather stations located proximally to the parcels of land. In some example embodiments, the temperature module 320 may provide a listing of the weather stations to the user to permit the user to select one or more weather stations from which to obtain temperature data. In some example embodiments, the temperature module 320 may access a list of weather stations located in the region of the parcels of land being used to grow the crop and may interpolate multiple stations to create a single measurement for that location, which may be adjusted for factors such as elevation, land cover, and proximity to bodies of water. Historical temperature data for the parcels of land or the area surrounding the parcels of land may be obtained from the selected one or more weather stations, or, alternatively, utilizing gridded temperature datasets.

The topography module 322 may access topography information for the parcels of land. The topography information may be stored within the application platform 102 or may be retrieved from a system external to the application platform 102. The topography information may alter temperature estimates of the parcels of land depending on the elevation of the parcels of land.

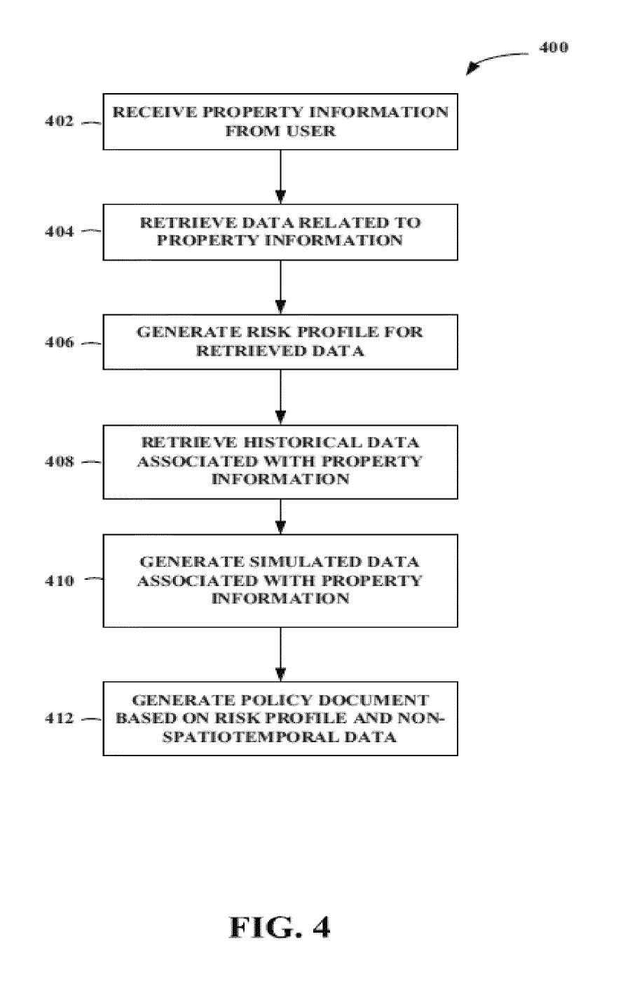

FIG. 4 is a flow diagram of a method 400 for generating a policy, according to some example embodiments. The method 400 may, for example, be deployed on the network system 100.

Referring to FIG. 4, at block 402, an application platform (e.g., the application platform 102) having one or more servers receives property information from a user. The property information may be input into an interactive form presented on a user interface of a client device (e.g., client devices 106, 108). Property information may include location information, a type of crop being grown at the location, user identification information, crop-related information such as historical crop yields and an expected yield, and information about other insurance policies. At block 404, based on the received property information, the application platform may retrieve data related to the property information. The data may pertain to specific land parcels or other land units (e.g., lot and block, geographic coordinates, CLU information, or the like), weather information related to the land parcels, crop information, and so forth.

At block 406, the application platform may generate a risk profile for the retrieved data. The risk profile may comprise a plurality of perils that might afflict the crop and the probability that such an occurrence might occur. It is noted that different crops may face different perils.

At block 408, historical data related to the property information may be retrieved. Historical data may include historical crop yields for the farm or the region surrounding the farm, historical temperature and precipitation information for the farm, and prior insurance claims made by users in the region surrounding the farm.

At block 410, simulated data may be generated with respect to temperature and/or precipitation data. Such simulations may be warranted if the temperature and precipitation data is obtained from a location other than the farm growing the crop. In some example embodiments, a predetermined number of simulations may be generated to obtain a statistically significant sample for generating an estimate of the temperature and/or precipitation of the land parcels being insured.

At block 412, a policy document is generated based on the risk profile and the weather information. The policy document may specify a premium to be paid to purchase the coverage. The policy document may further specify one or more payout schedules that describe the amount to be paid for each occurrence of a peril that exceeds the policy coverage limits. The policy document may be returned to the client device, where a user may have the option to electronically purchase the policy. Accordingly, in an example embodiment, a policy document may be generated electronically on-line without engaging with a third party such as an insurance agent. Users and an insurance provider may thus transact directly without requiring any intermediate party.

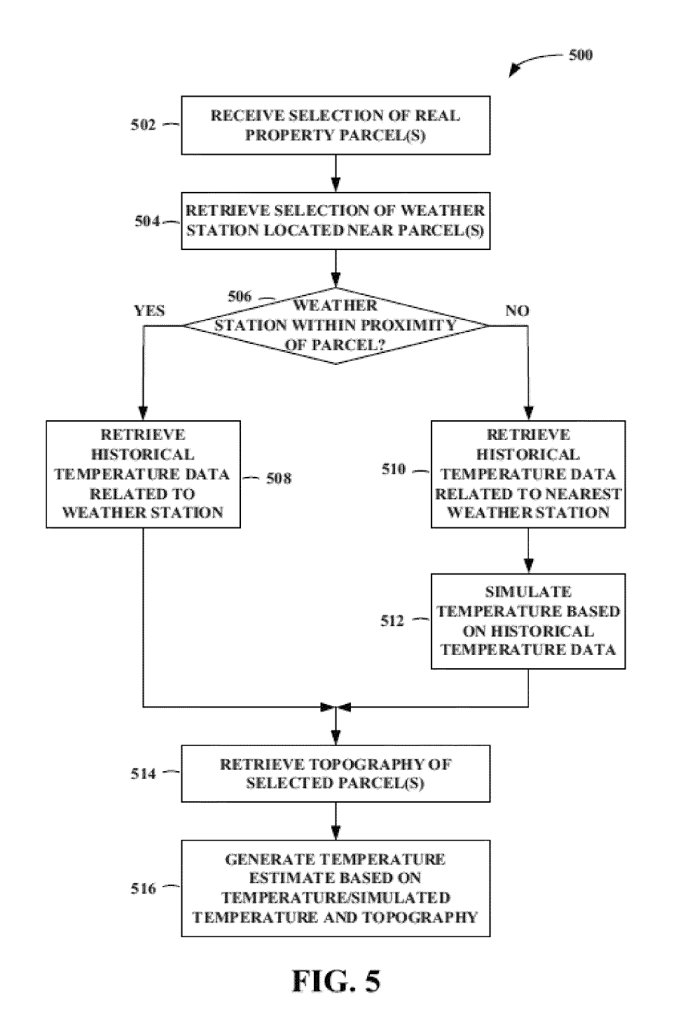

FIG. 5 is a flow diagram of a method 500 for estimating the temperature of a property parcel, according to some example embodiments. The method 500 may, for example, be deployed on the network system 100.

At block 502, an application platform (e.g., the application platform 102) may receive the selection of one or more land parcels on which a crop is being grown. The land parcels may be selected from a map that is graphically displayed on a client device. In other example embodiments, the land parcels may be selected based on identifying data provided by the user.

At block 504, one or more weather stations located near the land parcels may be selected by a user. In other example embodiments, such weather stations may be automatically selected upon identification of the land parcels.

At decision block 506, it is determined whether the weather station is located within a predetermined proximity of the parcel. If the weather station is located within a predetermined proximity of the parcel, at block 508, historical temperature data may be retrieved from the weather station. If the weather station is not located within the predetermined proximity of the parcel, at block 510, temperature data from one or more weather stations nearest to the land parcels is retrieved. Based on the retrieved data, at block 512, an estimated temperature for the land parcels may be simulated.

At block 514, in some example embodiments, the topography of the selected land parcels may be retrieved. The topography may be used to adjust the simulated temperature data.

At block 516, a temperature estimate may be generated based on the historical temperature data, the simulated temperature data, and the topology of the land parcels. The temperature estimate may represent an expected range of temperatures for the growth cycle of the crop being insured. Further, the temperature estimate may include temperature limits for determining whether certain perils have occurred or whether the temperature is within acceptable limits for growing the crop.

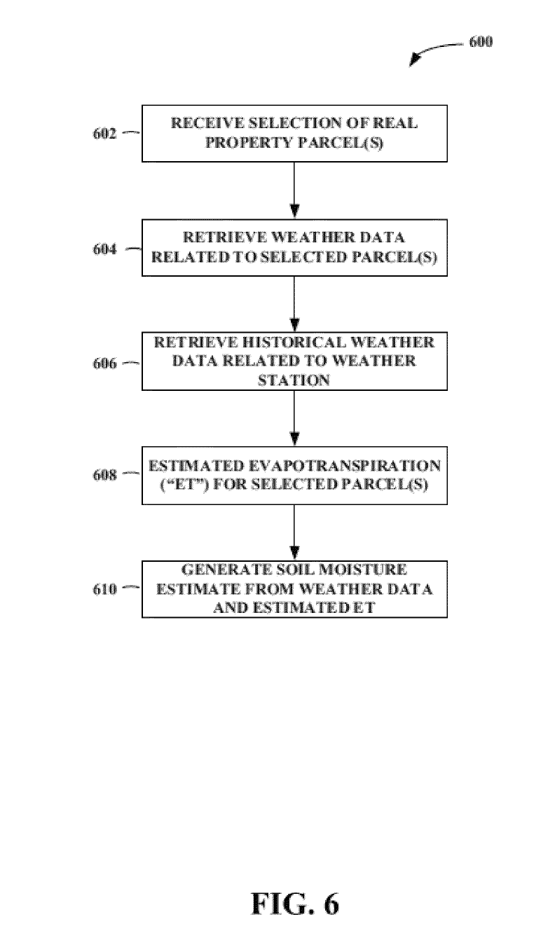

FIG. 6 is a flow diagram of a method 600 for estimating soil moisture for a property parcel, according to some example embodiments. The method 600 may, for example, be deployed on the network system 100.

At block 602, an application platform may receive the selection of one or more land parcels on which a crop is being grown. The land parcels may be selected from a map that is graphically displayed on a client device (e.g., the client devices 106, 108). In other example embodiments, the land parcels may be selected based on identifying data provided by the user.

At block 604, weather data related to the selected parcels may be retrieved. Weather data may include precipitation data. In some example embodiments, the weather data may be retrieved from sources external to the application platform.

At block 606, historical temperature data may be retrieved for the land parcels in question. Temperature data may be retrieved from one or more weather stations located near the land parcels.

At block 608, the evapotranspiration (ET) of the soil of the land parcels may be estimated. Evapotranspiration may be estimated as a function of the precipitation of the land parcels, the temperature of the land parcels, the crop growth stage, wind, humidity, solar radiation, day length, and the soil type.

At block 610, a soil moisture estimate may be generated from the weather data and the estimated evapotranspiration. The soil moisture estimate may be used in generating the policy and determining when a peril has exceeded the limits set forth on the policy.

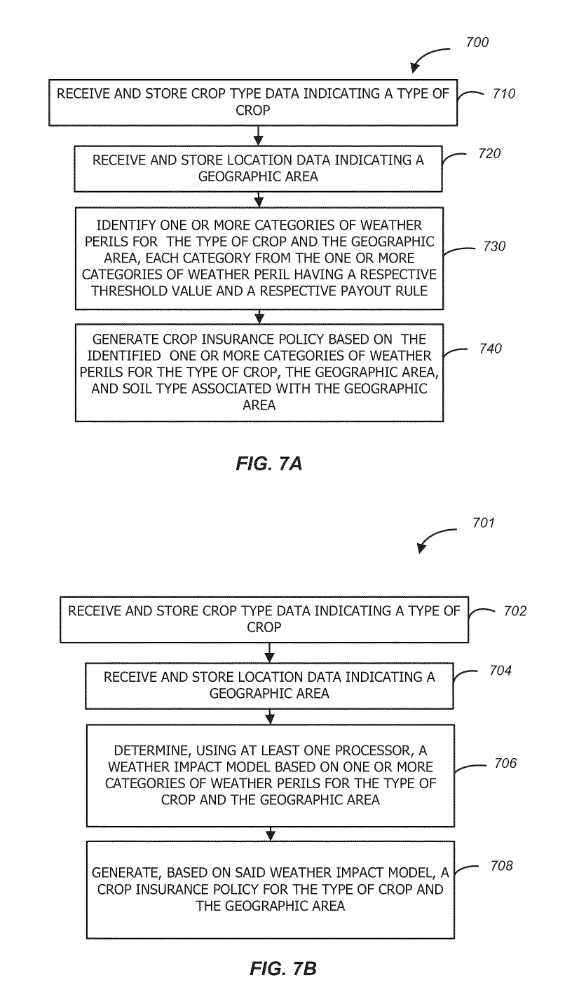

FIG. 7A is a flow diagram of a method 700 for generating a policy to provide crop protection coverage against weather-related perils, according to some example embodiments. The method 700 may, for example, be deployed on the network system 100.

At block 710, crop type information is received, e.g., via a user interface from a user. The crop type information may specify the crop being grown and, in some example embodiments, the breed of the crop. At block 720, location data may be received, e.g., via a user interface from a user. An example user interface for obtaining location data indicating geographic area where the crop that is the subject of prospective insurance policy is being or is to be grown. The location data may be as generic as a county or region of a state or province, or may be as specific as the coordinates or boundaries of a farm. In some example embodiments, location data selected by a user on a graphical map may be received. Based on the geographic location of the area of where the crop that is the subject of prospective insurance policy is being or is to be grown, soil type data may be determined, e.g., by accessing a database storing soil type data. In some embodiments, soil type data may be provided by the user. The soil type data may specify soil texture and/or soil classification. In some example embodiments, the soil type data may further specify a mineral composition of soil.

Based on one or more of the received crop type data, location data, and soil type data, one or more perils may be identified for the crop at block 730. The perils faced by the crop may be unique or dependent on the crop type. For example, corn may face different perils than soybeans or winter wheat.

A category of a weather peril may be associated with the type of crop and the geographic area having a respective threshold value and a respective payout rule. In some example embodiments, the perils may comprise weather perils. The payout rule may be determined based on tracked progress of crop identified by the type data and the location data. The tracking of the progress of crop growth may be performed by a growth tracker module described above with reference to FIG. 3A. In some embodiments, a range of dates during which each peril may be encountered may be determined. The range of dates may be compared to the growth cycle of the crop. The range of dates may be based on weather data, both historical and simulated. In some example embodiments, the weather data may include temperature and precipitation data. The range of dates may be for each weather peril corresponding to a portion of the planting season for the type of crop indicated by the crop type data may be adjusted, based on an agronomic model of crop growth. In some embodiments,

In one embodiment, a threshold for each peril is determined. The threshold may specify the maximum allowable occurrence of a peril. For example, heat stress may affect the growth of a crop. Heat stress may be defined as an amount of time the crop is exposed to an elevated temperature. In some example embodiments, the threshold for heat stress may relate to the amount of time the crop is exposed to elevated temperatures. In some example embodiments, the threshold for heat stress may relate to the temperature and whether the temperature to which the crop is exposed exceeds a threshold temperature. In other example embodiments, perils may be based on soil moisture, and the threshold may be based on an estimate of soil moisture. For example, excessive soil moisture may be considered a peril for certain crops. A lack of soil moisture (e.g., drought-like conditions) may be considered a peril for certain crops as well. Soil moisture-based peril thresholds may be dependent on a predetermined amount of time that the soil moisture is estimated to be above or below the threshold. Estimation of soil moisture may depend on precipitation and estimated evapotranspiration, which, in turn, may be dependent on the soil type.

One or more payout rules may be determined based on the crop type and perils. The payout rules may specify the amount that the insurance policy will pay out if the crop is exposed to a peril that exceeds the threshold for the peril.

The threshold and payout rules for each peril may be presented to a client device associated with a user. In some example embodiments, the threshold and payout rules for each peril may be displayed with a generated policy document specifying insurance coverage for the specified crop. A user may be presented with a selection of one or more policies having respective coverage levels and the user may request that a policy be generated for the displayed threshold and payout rules. In some other example embodiments, the selectable user interface element may enable a user to purchase the policy having the displayed threshold and payout rules. At block 740 the policy generation module 316 of FIG. 3A generates crop insurance policy based on the identified one or more categories of weather perils for the type of crop, the geographic area and soil type associated with the geographic area.

FIG. 7B is a flow diagram of a method 701 for generating a policy, according to some example embodiments. The method 701 may, for example, be deployed on the network system 100. At operation 702, a lookup module receives and stores, using the at least one processor, crop type data indicating a type of crop. At operation 704, a location module receives and stores, using the at least one processor, location data indicating a geographic area. At operation 706, a weather modeling module determines, using at least one processor, a weather impact model based on one or more categories of weather perils for the type of crop and the geographic area. At operation 708, a policy generation module to generates, using the at least one processor, based on said weather impact model, a crop insurance policy for the type of crop and the geographic area.

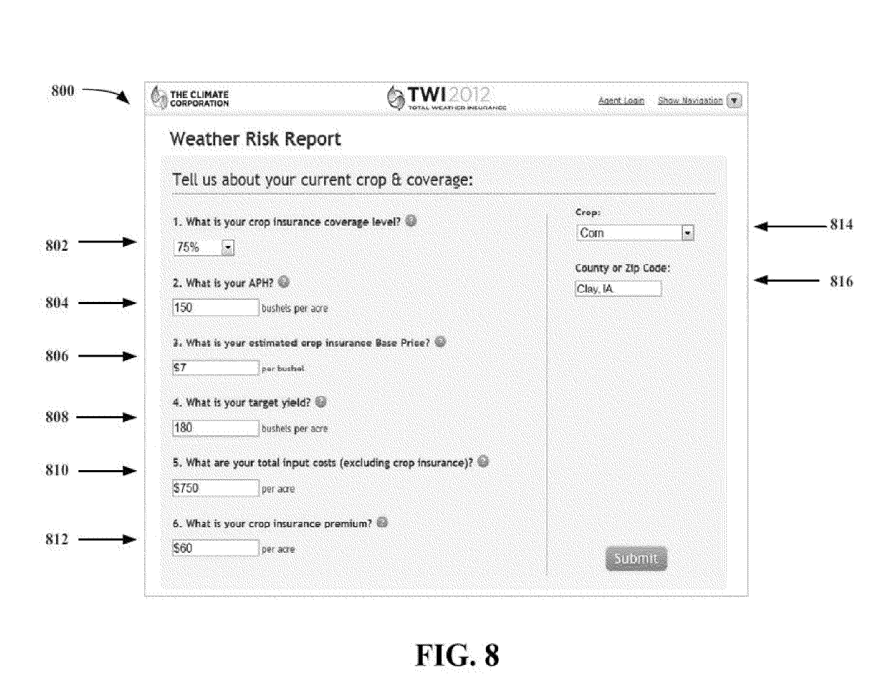

FIG. 8 is a diagram of a user interface 800 for generating a policy, according to some example embodiments. The user interface 800 may prompt a user to input data for use in formulating a policy for protecting a crop against certain perils. For example, a user interface element 814 may prompt a user to enter the crop for which the user seeks coverage. In some example embodiments, the user interface element 814 may be a dropdown menu, one or more radio buttons corresponding to different crops, a text box for entering a crop, or the like. A user interface element 816 may prompt a user to enter a county or zip code as the geographic location where the crop will be grown. A user interface element 802 may prompt a user to enter a current crop insurance level. A user interface element 804 may prompt a user to enter the actual production history of the crop, in terms of bushels per acre. Additional user interface elements 806, 808, 810, and 812 may prompt a user to input information about the user's estimated crop insurance base price, target yield, total input costs, and crop insurance premium.

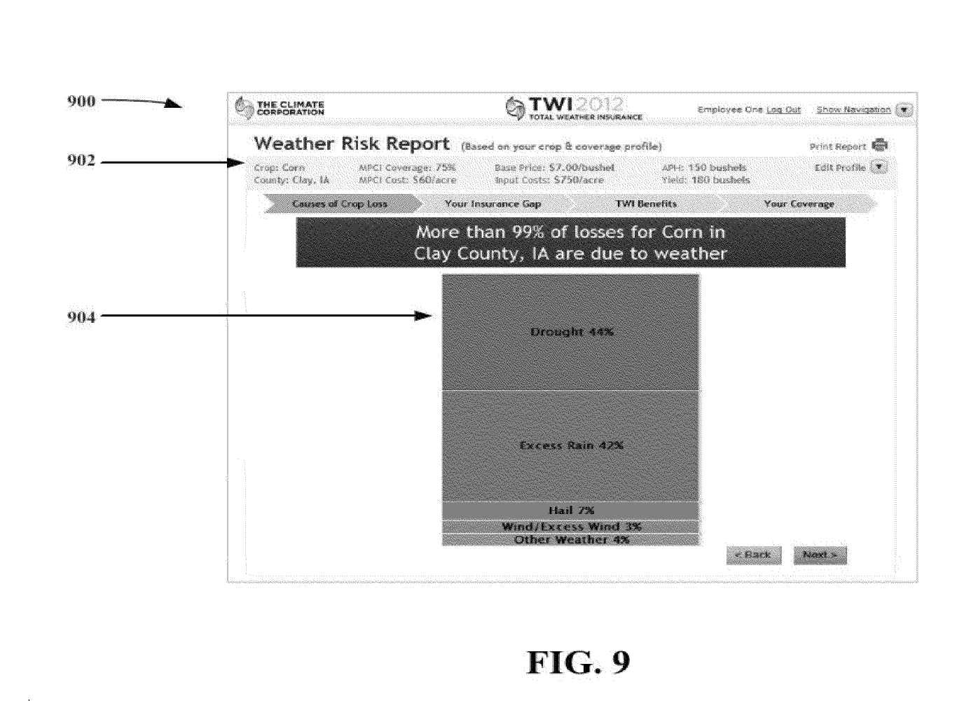

FIG. 9 is a diagram of a user interface 900 for providing a graphical display of weather risk for a property parcel, according to some example embodiments. The user interface 900 may display a risk report for relying solely on existing crop insurance coverage. The parameters entered by the user in the user interface 800 of FIG. 8 may be displayed on the user interface 900 as identified by interface element 902. A graphical display zone 904 within the user interface 900 may specify the various perils that may affect the selected crop at the geographic location specified by the user. For example, referring to FIG. 9, the graphical display zone 904 may display a bar graph that specifies that 99% of losses for corn in Clay County, Iowa are due to drought, excess rain, hail, wind, and other weather. Although a bar graph is shown by way of example, other graphical display types (e.g., pie graphs, line graphs, histograms, etc.) may be used to illustrate the data. For example, the presented information with respect to the causes of loss does not need to be county specific and instead display estimates of causes of loss specific to the customer's fields.

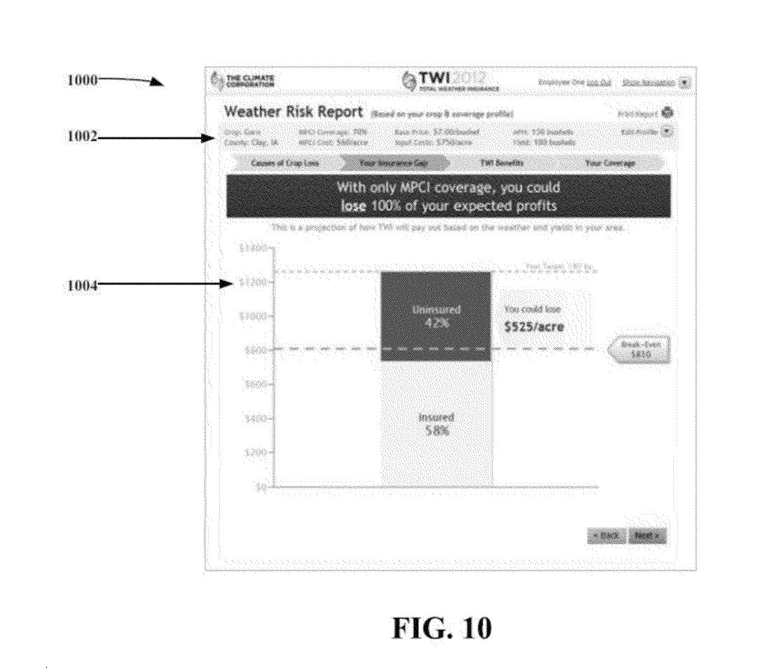

FIG. 10 is a diagram of a user interface 1000 for displaying a risk exposure for reliance solely on MPCI coverage, according to some example embodiments. The user interface 1000 may display a gap in coverage under the user's existing crop insurance coverage. The parameters entered by the user in the user interface 800 of FIG. 8 may be displayed in the user interface 1000 as identified by interface element 1002. A graphical display zone 1004 within the user interface 1000 may display a bar graph that specifies the expected loss of profits if the user solely relies on existing crop insurance coverage. Although a bar graph is shown by way of example, other graphical display types (e.g., pie graphs, line graphs, histograms, etc.) may be used to illustrate the data.

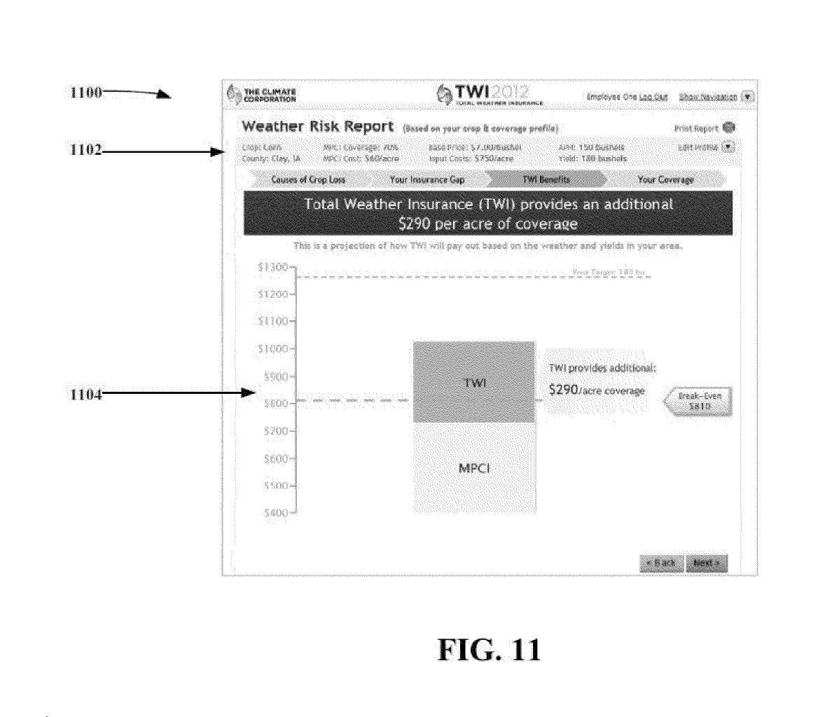

FIG. 11 is a diagram of a user interface 1100 for displaying the benefits of a supplemental insurance policy, according to some example embodiments. The user interface 1100 may graphically display the benefits of purchasing a supplemental insurance policy for protecting a crop from various weather-related perils. The parameters entered by the user in the user interface 800 of FIG. 8 may be displayed in the user interface 1100 as identified by interface element 1102. A graphical display zone 1104 may illustrate, in bar graph form, how the supplemental insurance policy may protect against losses to the crop caused by weather-related perils. Additionally, the graphical display zone 1104 may specify an amount of additional coverage per acre that the supplemental insurance policy may provide. Although a bar graph is shown, other graphical display types (e.g., pie graphs, line graphs, histograms, etc.) may be used to illustrate the data.

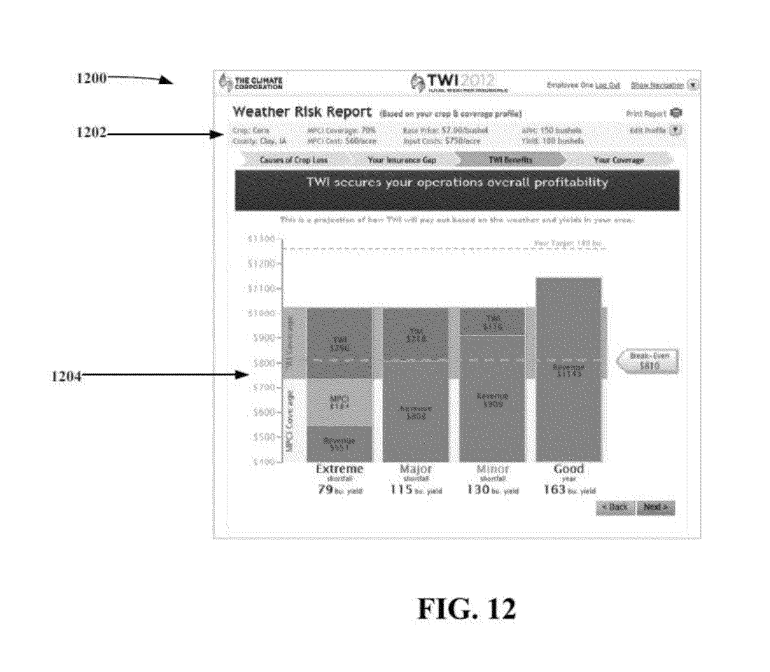

FIG. 12 is a diagram of a user interface 1200 for illustrating the benefits of a supplemental insurance policy for various situational outcomes, according to some example embodiments. The user interface 1200 may graphically display how the supplemental insurance policy may secure the profitability of a crop for a user. The parameters entered by the user in the user interface 800 of FIG. 8 may be displayed in the user interface 1200 as identified by interface element 1202. A graphical display zone 1204 may illustrate, in the form of a bar graph, various crop yield projections and the amount of revenue and insurance coverage for each projection. Although a bar graph is shown, other graphical display types (e.g., pie graphs, line graphs, histograms, etc.) may be used to illustrate the data.

FIG. 13A is a diagram of a user interface 1300 for illustrating the benefits of a supplemental insurance policy for different perils and different stages of maturity for an agricultural product, according to some example embodiments. The user interface 1300 may graphically display how the weather-related perils overlap with a growth cycle of a crop. For example, with respect to corn, the growth cycle 1302 is shown, and weather-related perils 1304 that might afflict corn are shown. As FIG. 13A illustrates, during the emergence stage of growth for corn, the crop may be afflicted by both precipitation-related perils (e.g., planting rain) and temperature-related perils (e.g., low heat units or freeze). As corn matures into the vegetative growth phase, corn may suffer from excess rain, drought, daytime heat stress, and/or freeze. The user interface 1300 further may illustrate the percentage of payout offered by the supplemental insurance policy compared to the primary crop insurance coverage. FIG. 13B is a diagram of a user interface associated with a growth stage tracker module. A growth stage tracker, in one example embodiment, tracks the progress of the specified crop using Heat Units and Relative Maturity. The progress estimate is adjusted for early or delayed planting by tracking early season temperature and precipitation. Within the Planting Window, the Field Work Day Threshold and Trigger can determine an Estimated Planting Date. Starting on the Estimated Planting Date, Growth Stages are used to determine the timing for each of the perils.

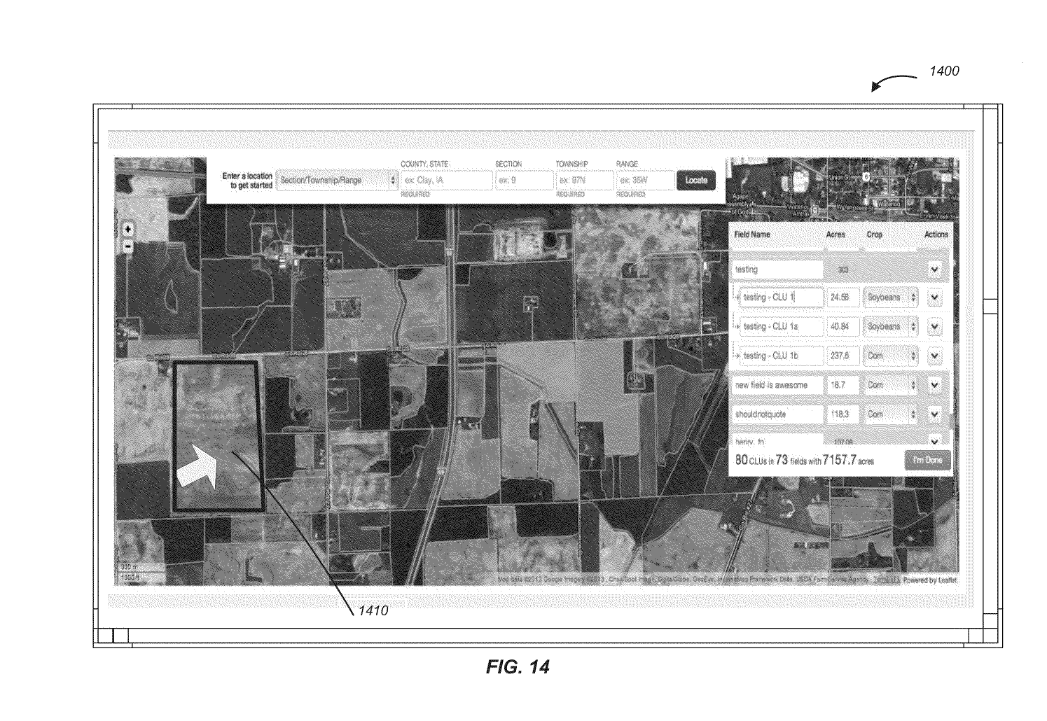

FIG. 14 is a diagram of a user interface 1400 for receiving a selection of a location data, according to some example embodiments. The graphical user interface 1400 may illustrate a plan view of a region of land that corresponds to the region entered by the user as being the region where the crop will be grown. In some example embodiments, the view may be a satellite-based image or any other form of a map. The graphical user interface 1400, the map of the region includes information regarding one or more CLUs associated with the displayed geographic region. As the user clicks on or hovers over a point on the displayed on the map, the location module 306 of FIG. 3 determines the associated CLU and highlights the portion of the displayed map that corresponds to that CLU. The user may then select the associated field by double clicking on the highlighted region or by some other control operation. An example of selected field is indicated by the reference numeral 1410.

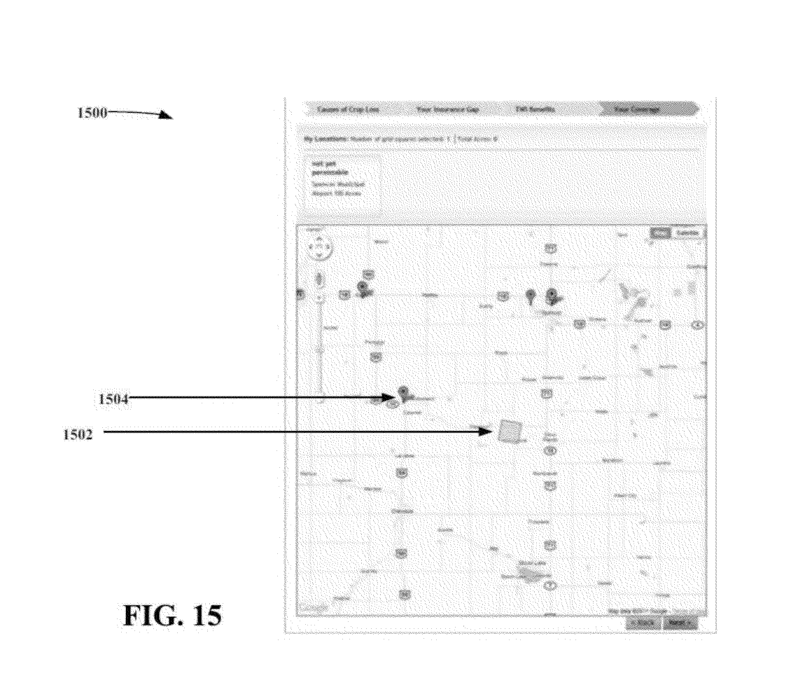

FIG. 15 is a diagram of an example user interface 1500 for receiving a selection of a weather station, according to some example embodiments. The graphical user interface 1500 may illustrate a map of the region entered by the user as being the region where the crop will be grown. In some example embodiments, the region entered may be identified by a user interface element, such as element 1502. One or more weather stations (e.g., element 1504) that may sample temperature data may be identified on the map. In some example embodiments, the user may select one or more weather stations for use in determining the temperature of the land being used to grow the crop. In other example embodiments, the application platform may automatically select the nearest weather station(s) to the land. To the extent the weather stations 1504 are not located near the land, temperature simulations may be performed to generate an estimate of the temperature of the land.

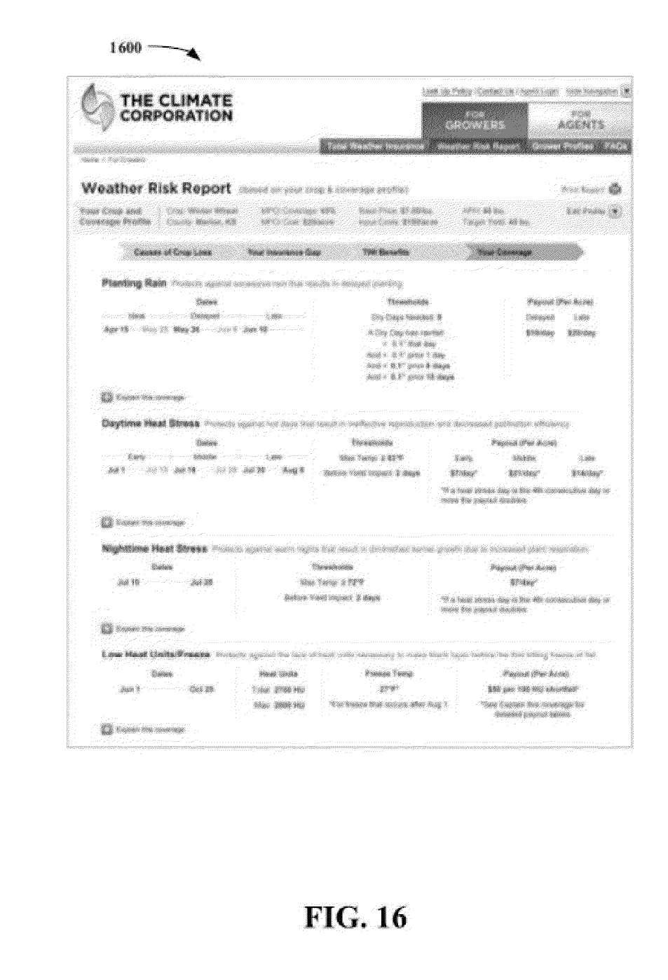

FIG. 16 is a diagram of a user interface 1600 of a weather risk report for an agricultural producer, according to some example embodiments. Based on the data input by the user, for example, in the user interface 800 of FIG. 8, and the selection of one or more precipitation grids, as shown in FIG. 14, and one or more weather stations, as shown in FIG. 15, the application platform may generate a weather risk report for the user. The weather risk report may specify one or more weather-related perils that may affect the crop, a threshold for each weather-related peril, and a payout schedule for each occurrence of the weather-related peril.

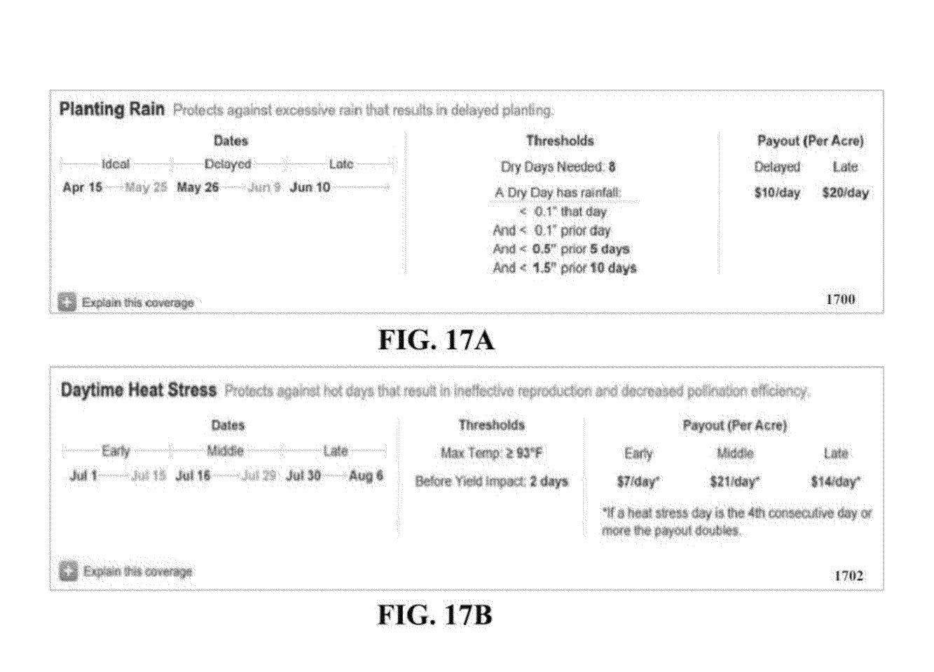

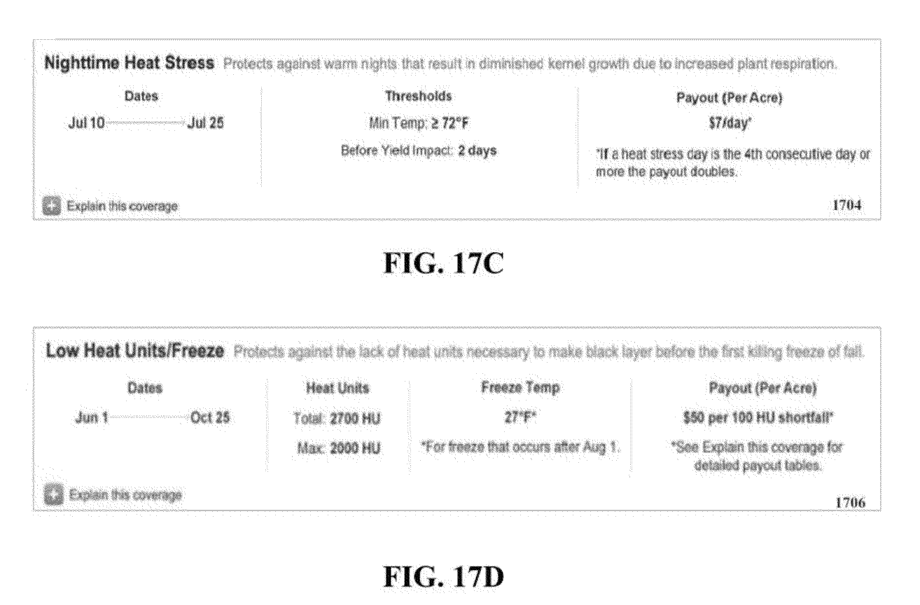

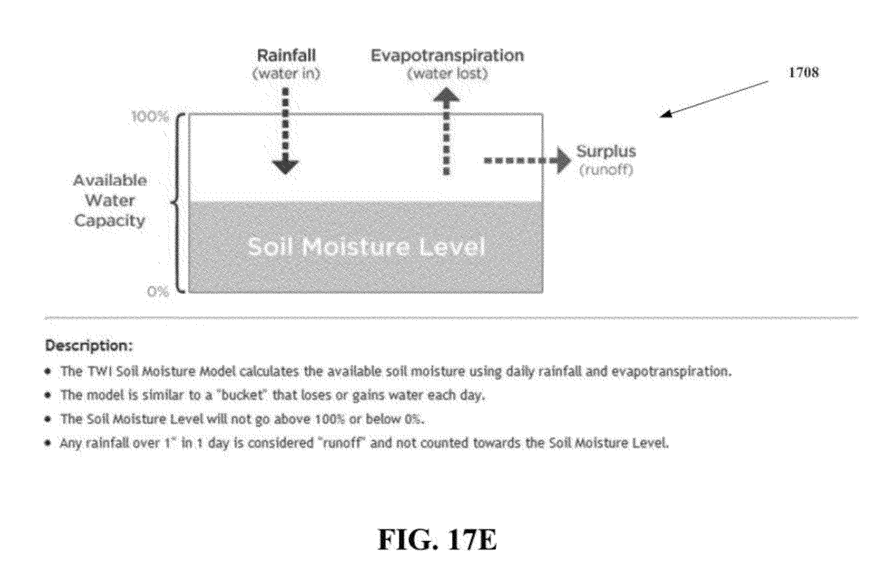

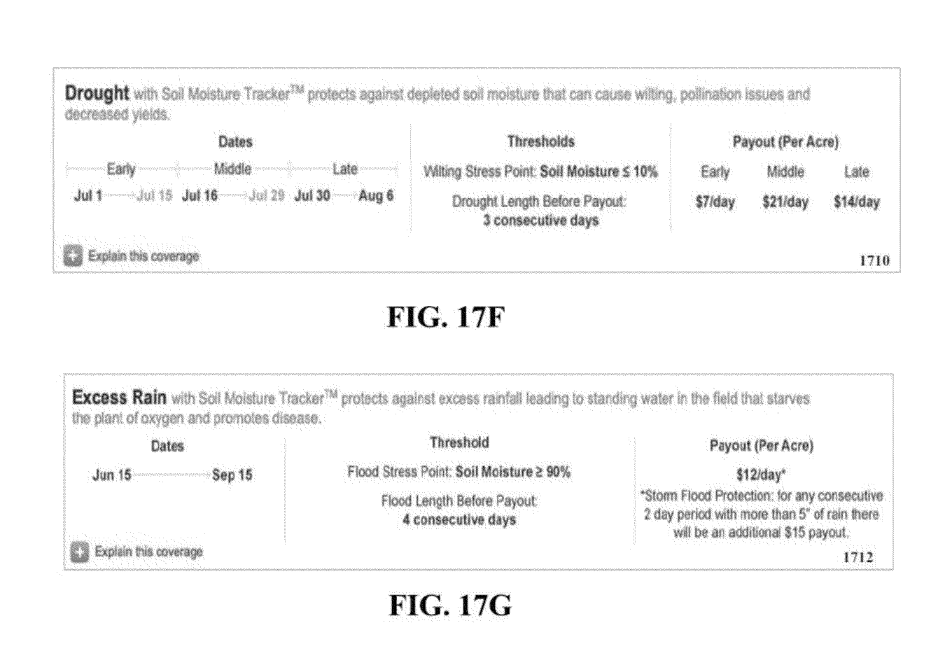

FIG. 17A is a diagram of a user interface 1700 for depicting coverage against a first peril, according to some example embodiments. Referring to FIG. 17A, a portion of the weather risk report that details a specific weather-related peril is shown. In particular, a planting rain peril may be illustrated for corn. Planting Rain protection may ensure the grower coverage in case they cannot get their crop planted in time because of excess rains. Timely planting is important, as studies have shown that delays can have a negative impact on yields. Regular small rains or occasional heavy rains during the planting period can leave the field too wet for equipment and proper seeding. Excess rain can prevent planting of certain acreage, force growers to switch to a lower yielding variety, or reduce optimal establishment of the plant, thereby leading to reduced yields. This coverage is designed to guarantee the grower enough Dry Days during the ideal period to get fully planted. For each day of the coverage period, rainfall is tracked over that day and the prior to determine if excess rain will keep the grower out of the fields. If the number of planting Dry Days is not achieved by the time the Delayed planting period begins, the grower will be paid for each day. Planting Rain protection specifies the number of Dry Days Needed to get fully planted. To qualify as a Dry Day, the rainfall on that day (the current day) must be below a threshold amount, and the rainfall during certain prior periods must also be below certain threshold amounts. Those prior periods, which are defined above, are overlapping and all end on the day before the current day. Payouts will increase if the number of Dry Days is not achieved at the start of the defined Late Period. Payouts for this coverage are based on the number of required Dry Days that occur during the Delayed and Late planting periods. For example, if there are 8 Dry Days Needed and only 4 occur during the Ideal planting period, the payout calculation is based on when the remaining 4 Dry Days occur (either during the Delayed period or Late period).

FIG. 17B is a diagram of a user interface 1702 for depicting coverage against a second peril, according to some example embodiments. Referring to FIG. 17B, a portion of the weather risk report 1600 that details a specific weather-related peril is shown. In particular, a daytime heat stress peril may be illustrated for corn. Daytime Heat Stress coverage may protect the grower from high temperatures during the critical pollination period. Excess heat during this time will result in un-pollinated kernels and reduced yields at the end of the season. The plant will be able to withstand some heat stress before significant yield impact. High daytime temperatures limit pollination and can stress the plant during key growth periods. The coverage time frame for Heat Stress Protection may be broken into 3 distinct periods with greatest payouts occurring during peak reproductive growth/pollination as heat during this period is most detrimental to yields. In another example, there may be no “Middle” period for soybean coverage. Consecutive days of heat stress result in more significant yield loss. To account for this, daily payouts may be doubled for each day that is at least the third consecutive day of heat stress. For example, once the grower receives a third Heat Stress Day from July 14th through August 11^{th}, payouts will begin for each day with temperatures at or exceeding 95 degrees. The daily payouts may be largest during the middle period when pollination is most critical. If a heat stress day is more than the second consecutive Heat Stress Day, this is a Heat Wave Day and the payout for that day may be twice the amount listed below. This coverage will thus pay for each day during the coverage period when the maximum temperature meets or exceeds the Daytime Heat Stress Maximum Temperature, once the Events Before Yield Impact is exceeded.

FIG. 17C is a diagram of a user interface 1704 or depicting coverage against a third peril, according to some example embodiments. The portion of the weather risk report 1600 that details a specific weather-related peril is shown. In particular, a nighttime heat stress peril may be illustrated for corn. While the negative impact of high daytime temperatures has been a long-standing concern for growers, there have been more recent discoveries that high nighttime temperatures can be just as detrimental to the plant. If nighttime temperatures remain high this may cause the plant to use its energy in increasing respiration rather than building grain. This diversion of energy from grain fill to maintenance of the plant cell is diverting sugars that can lead to less than optimum yield and lower test weights. This coverage timeframe for Nighttime Heat Stress is when grain fill typically occurs. The amount of the payout for Nighttime Heat Stress Days is specified in the user interface. However, there is no payout for the first certain number of Nighttime Heat Stress Days, identified as the Days Before Yield Impact in the user interface portion 1704. Consecutive Nighttime Heat Stress Days typically result in more significant yield loss. To account for this, daily payouts may be increased as described above for a day that is more than the second consecutive Nighttime Heat Stress Day.

FIG. 17D is a diagram of a user interface 1706 for depicting coverage against a fourth peril, according to some example embodiments. The portion of the weather risk report 1600 that details a specific weather-related peril is shown. In particular, a low heat units/freeze peril may be illustrated for corn. Growth and development of corn are strongly dependent on temperature. This is measured by the calculation of Heat Units, also known as Growing Degree Days or GDDs. Heat Units (or GDDs) for a particular day may be calculated by counting degrees above 50° F. up to 86° F. for minimum and maximum temperature and averaging the results. For example, if daily maximum temperature is 90° F. and minimum temperature is 72° F., then Heat Units=(72−50)/2+(86−50)/2=29; and if daily maximum temperature is 68° F. and minimum temperature is 41° F., then Heat Units=(50−50)/2+(68−50)/2=9. Heat Unit accumulation stops on the day that the minimum temperature reaches or falls below the Freeze Temp on or after the date indicated above. Coverage may be provided for Low Heat Units and Freeze to protect against a shortage of temperatures required for plant development from seedling emergence until physiological maturity (black layer). When a frost does occur to immature corn, the concern will be with impact on final grain yield and “dry-down rate.” In a cool summer, a plant may not fully mature and achieve full yield potential before the first killing freeze of the fall. In this example, if the minimum temperature for any day is at or below the Freeze Temp anytime after August 1, the accumulation of heat units will stop and be reported to that date. This will help to cover the likely increased drying costs as a result of the higher moisture. Corn could also exhibit lower test weight, which is a key indicator of quality in corn. In the example embodiment of FIG. 17D, this coverage will pay if there is a shortfall of accumulated Heat Units below 2700 HU with a maximum payout occurring at or below 2000 HU.

FIG. 17E is a diagram of a user interface 1800 for depicting a soil moisture model, according to some example embodiments. The soil moisture model may improve the coverage of Drought and Excess Rain throughout the growing season. For each Precision Rainfall Grid™ (e.g., 2.5×2.5 mile grid) the soil moisture model may estimate the amount of water entering the soil each day through rainfall and the amount of water leaving the soil each day through plant water use and evaporation. If the daily soil moisture value estimated by the soil moisture model exceeds the stress point for either drought or excess moisture (a threshold specified in each policy as the level of too little/too much soil moisture at which negative yield impact is typically expected to occur), each day it remains beyond the stress point is counted as a stress day. Consecutive days of excess moisture or drought stress typically negatively impact yields and thus trigger payouts. The soil moisture model may estimate the available soil moisture for each day using daily rainfall and estimated evapotranspiration. Soil type and soil depth/root zone are important factors used in determining available soil moisture on each day. The soil moisture value on a given day may be determined by first adding the rainfall for that day (e.g., capped at an amount at which runoff is typically expected to occur) to the soil moisture value from the previous day, and then subtracting the evapotranspiration value for that day.

FIG. 17F is a diagram of a user interface 1710 for depicting coverage against a fifth peril, according to some example embodiments. The portion of the weather risk report 1600 that details a specific weather-related peril is shown. In particular, a drought peril may be illustrated for corn. Drought during pollination and grain fill of corn can have a big impact on yields. Insufficient soil moisture during the vegetative, reproductive, and grain fill growth stages may reduce yield. The Drought coverage may protects growers who do not get enough moisture during pollination and grain fill to have a successful yield. A Drought Day includes a day during the Dates specified in the user interface 1710 for which the Soil Moisture percentage is less than or equal to the Drought Threshold for that day and for the number of immediately prior, consecutive days specified above. The amount of the payout depends on whether the Drought Day occurs during the Early period, Middle period, or Late period, since the drought stress occurring during reproduction (the Middle period) typically has the biggest impact on yield. This coverage may pay out for any day for which the Soil Moisture percentage is less than or equal to the Drought Threshold for that day and for the number of immediately prior, consecutive days specified above. For example, if that number of immediately prior consecutive days is 3 days, then June 15 would be a Drought Day if the Soil Moisture is less than or equal to the Drought Threshold on June 12, 13, 14 and 15. If the rainfall on June 16 causes the Soil Moisture to exceed the Drought Threshold for that day, then there would not be a payout for June 16, and the soonest the user may be entitled to another payout would be June 20.

FIG. 17G is a diagram of a user interface 1712 for depicting coverage against a sixth peril, according to some example embodiments. The portion of the weather risk report 1600 that details a specific weather-related peril is shown. In particular, an excess rain peril 1712 may be illustrated for corn. The effects of excess rain in a grower's fields can be just as dramatic as drought on yields. When soil is saturated to the point of standing water (Flood Stress), the plant may be starved of oxygen, and will leech nutrients from the soil, increasing the likelihood of disease and ultimately decreasing yields. Regardless of soil saturation, significant rainfall over a short time (Storm Flood) typically causes standing water in the field, which can also lead to yield loss. Too much moisture may also cause fertilizer leaching which depletes the soil of nutrients and also causes poor oxygen availability in the soil for uptake by the roots. This can promote disease and fungus formation in a grower's fields. The excess rain peril may ensure that there is protection in place to make up for possible yield loss if there are multiple days of saturated soils. Additionally, if there is a significant amount of rainfall in a short period, the excess rain peril protects against floods caused by storms. If a grower gets more than 5 inches of rain over any consecutive two-day period, in this example, there may be an additional $15.00 payout per acre in addition to any Excess Rain payout due to saturated soils.

A Flood Stress Day includes a day for which the soil moisture percentage is greater than or equal to the Flood Stress Point for that day and for a certain number of immediately prior, consecutive days, as specified above. For example, if that number is 4 out of the immediately prior 5 consecutive days, then there would be a payout for June 15 if the soil moisture percentage is greater than or equal to the Flood Stress Point on June 15 and on June 10, 11, 12 and 14. If the evapotranspiration value on June 16 causes the soil moisture percentage to decline below the Flood Stress Point for that day, then there may be no payout for June 16, and the soonest the user may be entitled to another payout would be June 19. Because a short period of saturated Soil Moisture typically may not significantly impact yields, a day qualifies as a Flood Stress Day and is eligible for a Flood Stress payout only if the Flood Stress Point has been satisfied for that day and for the certain number of prior days specified above.

A Storm Flood is two consecutive days during the Dates with rainfall totaling at least 5 inches. The amount the user will be paid for that two-day period is specified in the user interface 1712. In addition, you will be paid for Storm Flood days as described in the user interface 1712, irrespective of the Flood Stress Point. If a storm flood occurs 5 out of the previous 6 days, then the user would be entitled to a payment for June 25 if the soil moisture model percentage is greater than or equal to the Flood Stress Point on June 21st, June 22nd, June 23rd, June 24th and June 25th. If the ET value on June 26th causes the soil moisture model percentage to decline below the Flood Stress Point for that day, then the user would receive no payment for June 26th, and the soonest the user may be entitled to another payment as described above would be July 2nd.

Thus, in some example embodiments, a computer-implemented method is described. The method may include operations selected from receiving and storing crop type data indicating a type of crop specified by a user, receiving and storing location data indicating a geographic area specified by the user, receiving and storing soil type data indicating a soil type specified by the user, identifying a plurality of categories of weather perils based, at least in part, on the crop type data specified by the user, determining at least one range of dates for each weather peril corresponding to a portion of the planting season for the type of crop indicated by the crop type data, determining, by a processor, a threshold for each category of weather peril based, at least in part, on historical data regarding the impact of the weather peril on crop yield for the type of crop indicated by the crop type data, wherein the threshold for at least a first category of weather peril is based, at least in part, on historical precipitation data for the geographic area and the soil type indicated by the soil type data, determining, by the processor, a payout rule specifying an amount to be paid if the threshold is exceeded for each range of dates for each category of weather peril, causing to be displayed to the user the threshold and the payout rule for each range of dates for each category of weather peril, and causing to be displayed at least one user interface element configured to be selected by the user to request at least one insurance policy based, at least in part, on the threshold and the payout rule for at least one category of weather peril.

The threshold for the first category of weather peril may be based, at least in part, on an estimate of soil moisture, a number of days that the estimate of soil moisture is below a specified level, and so on. In an example embodiment, the methods described herein may comprise determining, by the processor, an index for the first category of weather peril based, at least in part, on daily rainfall data for the geographic area, the soil type indicated by the soil type data, and an estimated evapotranspiration. The index may be based, at least in part, on a runoff level for the rainfall. The threshold for the first category of weather peril may be based, at least in part, on the index. Data indicating a temperature station data specified by the user may be received and stored.

The threshold for the first category may be based, at least in part, on temperature data for the temperature station, for example, specified by the user. The threshold for the first category may correspond to a drought condition, an excess rain condition, or any other precipitation related condition.

In some example embodiments, a second category of weather peril may be taken into account. The second category of weather peril may include the range of dates for the second category of weather peril that correspond to a planting season for the type of crop indicated by the crop type data, and the threshold for the second category of weather peril may be based, at least in part, on a number of days below a specified level precipitation.

As discussed herein, the geographic area may include a plurality of regions, for example, each region may have an area equal to or less than 25 square miles or less. In some example embodiments, each region has an area equal to or less than 6.25 square miles.

A user interface element for specifying the geographic area may be displayed. The user interface element may include user selectable grids on a map. Each grid may, for example, correspond to a region having an area equal to or less than 6.25 square miles or any other appropriate size for the particular location, crop, or other variable. The interface element may be configured to receive an identification of a property from the user. The geographic area corresponding to the property may then be automatically determined, without human intervention. The threshold for the first category of weather peril may be based on separate precipitation data for each region within the geographic area. In another embodiment, the selection of a geographic location by a user may be based on providing to the user field outlines, e.g., polygon-based selection of locations. In yet another embodiment, a user may be presented with a presentation of selectable geographic locations (e.g., fields) based on imported so-called shapefiles.

In some example embodiments, a computer-implemented method is described including operations selected from receiving and storing crop type data indicating a type of crop, receiving and storing location data indicating a geographic area, receiving and storing soil type data indicating a soil type, establishing a threshold for a category of weather peril for the type of crop indicated by the crop type data, wherein the threshold is based, at least in part, on precipitation data for the geographic area and the soil type indicated by the soil type data, establishing a range of dates for the category of weather peril corresponding to a portion of a planting season for the type of crop indicated by the crop type data, establishing a payout rule specifying amounts to be paid to a policy holder if the threshold is exceeded during the range of dates, wherein the amounts to be paid vary depending on a number of days during the range of dates that the threshold is exceeded, obtaining precipitation data for the geographic area for each day during the range of dates, calculating, by a processor, whether the threshold is exceeded for each day during the range of dates, calculating, by a processor, the payout rule to determine a payout amount to be paid for the range of dates based, at least in part, on the number of days that the threshold is exceeded during the range of dates; and arranging for the payout amount to be paid to the policy holder.

The threshold may be based on an index. The index may be calculated, by a processor, based, at least in part, on daily rainfall data for the geographic area, the soil type indicated by the soil type data, and an estimated evapotranspiration. The threshold may be calculated using separate precipitation data for each region within the geographic area.

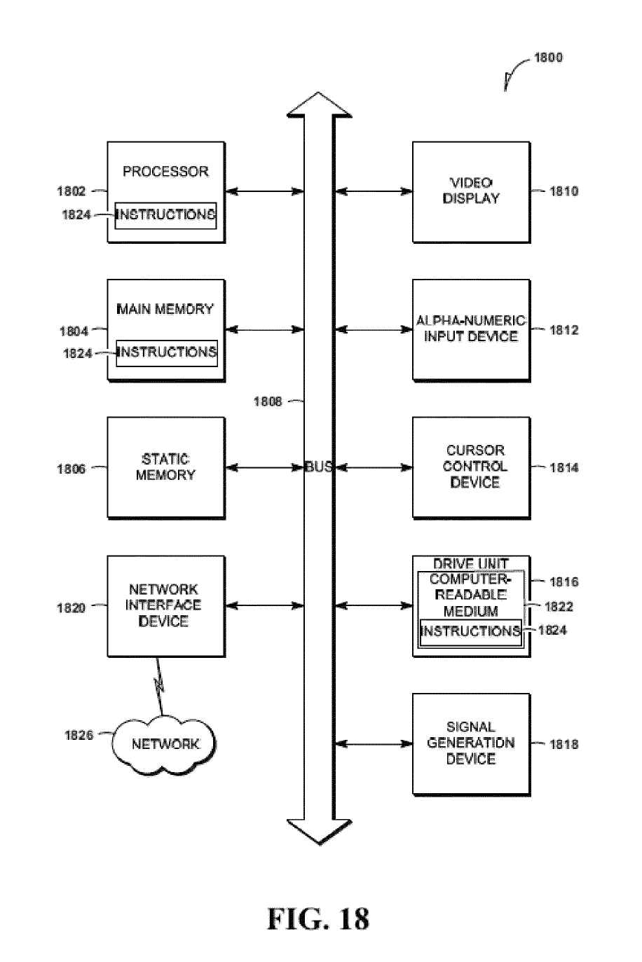

FIG. 18 shows a diagrammatic representation of machine in the exemplary form of a computer system 1800 within which a set of instructions, for causing the machine to perform any one or more of the methodologies discussed herein, may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a tablet, a smart mobile device, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU), or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a cursor control device 1814 (e.g., a mouse), a disk drive unit 1816, a signal generation device 1818 (e.g., a speaker) and a network interface device 1820.

The disk drive unit 1816 includes a machine-readable medium 1822 on which is stored one or more sets of instructions (e.g., software 1824) embodying any one or more of the methodologies or functions described herein. The software 1824 may also reside, completely or at least partially, within the main memory 1804 and/or within the processor 1802 during execution thereof by the computer system 1800, with the main memory 1804 and the processor 1802 also constituting machine-readable media. The software 1824 may further be transmitted or received over a network 1826 via the network interface device 1820.

While the machine-readable medium 1822 is shown in an exemplary example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals.

Certain example embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 1800) or one or more hardware modules of a computer system (e.g., a processor 1802 or a group of processors) may be configured by software (e.g., an application or application portion) as a hardware module that operates to perform certain operations as described herein.

In various example embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor 1802 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering example embodiments in which hardware modules are temporarily configured (e.g., programmed), each of the hardware modules need not be configured or instantiated at any one instance in time. For example, where the hardware modules comprise a processor 1802 configured using software, the processor 1802 may be configured as respective different hardware modules at different times. Software may accordingly configure a processor 1802, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (e.g., over appropriate circuits and buses) that connect the modules. In example embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors 1802 that are temporarily configured (e.g., by software, code, and/or instructions stored in a machine-readable medium) or permanently configured to perform the relevant operations. Whether temporarily or permanently configured, such processors 1802 may constitute processor-implemented (or computer-implemented) modules that operate to perform one or more operations or functions. The modules referred to herein may, in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 1802 or processor-implemented (or computer-implemented) modules. Similarly, at least some of the operations of a method may be governed by instructions that are stored in a computer readable storage medium and executed by one or more processors 1802 or processor-implemented (or computer-implemented) modules. The performance of certain of the operations may be distributed among the one or more processors 1802, not only residing within a single machine, but deployed across a number of machines. In some example embodiments, the processors 1802 may be located in a single location (e.g., within a home environment, an office environment or as a server farm), while in other example embodiments the processors 1802 may be distributed across a number of locations.

While the example embodiment(s) is (are) described with reference to various implementations and exploitations, it will be understood that these example embodiments are illustrative and that the scope of the example embodiment(s) is not limited to them. In general, techniques for the example embodiments described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the example embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the example embodiment(s).

The accompanying drawings that form a part hereof, show by way of illustration, and not of limitation, specific example embodiments in which the subject matter may be practiced. The example embodiments illustrated are described in sufficient detail to enable those skilled in the art to practice the teachings disclosed herein. Other example embodiments may be utilized and derived therefrom, such that structural and logical substitutions and changes may be made without departing from the scope of this disclosure. This Detailed Description, therefore, is not to be taken in a limiting sense, and the scope of various example embodiments is defined only by the appended claims, along with the full range of equivalents to which such claims are entitled.

Such example embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific example embodiments have been illustrated and described herein, it should be appreciated that any arrangement calculated to achieve the same purpose may be substituted for the specific example embodiments shown. This disclosure is intended to cover any and all adaptations or variations of various example embodiments. Combinations of the above example embodiments, and other example embodiments not specifically described herein, will be apparent to those of skill in the art upon reviewing the above description.

The preceding technical disclosure is intended to be illustrative, and not restrictive. For example, the above-described example embodiments (or one or more aspects thereof) may be used in combination with each other. Other example embodiments will be apparent to those of skill in the art upon reviewing the above description.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

1. A computer-implemented method comprising:
receiving and storing crop type data indicating a type of crop;
receiving and storing location data indicating a geographic area;
determining, using at least one processor, a weather impact model based on one or more categories of weather perils for the type of crop and the geographic area; and
generating, based on said weather impact model, using at least one processor, a crop insurance policy for the type of crop and the geographic area.

2. The method of claim 1, wherein the weather impact model comprises one or more sub-models, each of said sub-models having respective one or more threshold values and respective one or more payout rules.

3. The method of claim 1, wherein:
the determining of the weather impact model comprises identifying, for each category from the one or more categories of weather perils, one or more respective threshold values and one or more respective payout rules, a payout rule from the one or more payout rules specifying an amount to be paid if an associated threshold value from the one or more respective threshold values is exceeded.

4. The method of claim 3, comprising generating a plurality of crop insurance policies based on the identified one or more categories of weather perils for the type of crop and the geographic area and a respective coverage level, the crop insurance policy being from the plurality of crop insurance policies.

5. The method of claim 4, comprising receiving a selection of a crop insurance policy from the plurality of crop insurance policies, the selection being indicative of a request for the crop insurance policy by a user.

6. The method of claim 3, wherein the threshold for category from the one or more categories of weather peril is associated with one or more of an estimate of soil moisture, a number of days that the estimate of soil moisture is below a specified level, daily rainfall data for the geographic area, and an estimated evapotranspiration.

7. The method of claim 3, comprising:
establishing a range of dates for the category of weather peril corresponding to a portion of a planting season for the type of crop, wherein the payout rule utilizes a number of days within the range of dates when the threshold is exceeded; and
adjusting the established range of dates, based on an agronomic model of crop growth.

8. The method of claim 3, wherein the payout rule is determined based on tracked progress of crop growth identified by the type of crop and the geographic area, the progress of crop growth determined based on observed temperatures for the geographic area.

9. The method of claim 1, wherein a category from the one or more categories of weather peril comprises an excess rain condition, a drought, excessive rain, day time heat stress, and a freeze.

10. The method of claim 1, wherein the receiving of the location data comprises:
providing a map presentation to be displayed on a display device;
receiving a selection of a location on the map presentation;
identifying a common land unit associated with the selection of the location on the map presentation; and
identifying the common land unit as the geographic area.

11. A system comprising:
at least one processor coupled to a memory;
a lookup module to receive and store, using the at least one processor, crop type data indicating a type of crop;
a location module to receive and store, using the at least one processor, location data indicating a geographic area; and
a weather modeling module to determine, using at least one processor, a weather impact model based on one or more categories of weather perils for the type of crop and the geographic area; and
a policy generation module to, using the at least one processor, generate, based on said weather impact model, a crop insurance policy for the type of crop and the geographic area.

12. The system of claim 11, wherein the weather impact model comprises one or more sub-models, each of said sub-models having respective one or more threshold values and respective one or more payout rules.

13. The system of claim 11, wherein:
weather modeling module is to identify, for each category from the one or more categories of weather perils, one or more respective threshold values and one or more respective payout rules, a payout rule from the one or more payout rules specifying an amount to be paid if an associated threshold value from the one or more respective threshold values is exceeded.

14. The system of claim 13, wherein the policy generation module is to generate a plurality of crop insurance policies based on the identified one or more categories of weather perils for the type of crop and the geographic area and a respective coverage level, the crop insurance policy being from the plurality of crop insurance policies.

15. The system of claim 14, comprising a communications module to receive a selection of a crop insurance policy from the plurality of crop insurance policies, the selection being indicative of a request for the crop insurance policy by a user.

16. The system of claim 13, wherein the threshold for category from the one or more categories of weather peril is associated with one or more of an estimate of soil moisture, a number of days that the estimate of soil moisture is below a specified level, daily rainfall data for the geographic area, and an estimated evapotranspiration.

17. The system of claim 13, comprising a growth range tracker to:
establish a range of dates for the category of weather peril corresponding to a portion of a planting season for the type of crop, wherein the payout rule utilizes a number of days within the range of dates when the threshold is exceeded; and
adjust the established range of dates, based on an agronomic model of crop growth.

18. The system of claim 13, wherein the payout rule is determined based on tracked progress of crop growth identified by the type of crop and the geographic area, the progress of crop growth determined based on observed temperatures for the geographic area.

19. The system of claim 11, wherein a category from the one or more categories of weather peril comprises an excess rain condition, a drought, excessive rain, day time heat stress, and a freeze.

20. The system of claim 11, wherein the location module is to:
provide a map presentation to be displayed on a display device;
receive a selection of a location on the map presentation;
determine a common land unit associated with the selection of the location on the map presentation; and
determine the common land unit as the geographic area.

21. A machine-readable non-transitory storage medium having instruction data to cause a machine to:
receive crop type data indicating a type of crop;
receive location data indicating a geographic area;
determine a weather impact model based on one or more categories of weather perils for the type of crop and the geographic area; and
generate, based on said weather impact model, using at least one processor, a crop insurance policy for the type of crop and the geographic area.
